(19) United States
(12) Patent Application Publication
(10) Pub. No.: US 2006/0156551 A1
(43) Pub. Date: Jul. 20, 2006

(54) Method for manufacturing hair trimmer with non-slip handle

(75) Inventors: Anand Khubani, Towaco, NJ (US); Aaron Szymanski, Thomaston, CT (US)

Correspondence Address: EPSTEIN DRANGEL BAZERMAN & JAMES, LLP, 60 EAST 42ND STREET, SUITE 820, NEW YORK, NY, 10165, US

(73) Assignee: Ideavillage Products Corp.

(21) Appl. No.: 11/039,488

(22) Filed: Jan. 20, 2005

(51) Int. Cl. B21K 21/00; B26B 21/12

(52) U.S. Cl. 30/130; 30/30; 30/124; 76/101.1; 29/428

(57) ABSTRACT

The method for manufacturing the hand-held hair trimmer including forming a metal tubular intermediate member. First and second mirror image hollow semi-cylindrical grip parts are formed of non-slip material. The handle assembly is formed by placing the intermediate member between the grip parts and fixing the grip parts to the member and to each there by adhesive. The blade-carrying housing is inserted into the channel defined by the handle assembly and releaseably connected to the handle assembly in the fully inserted position.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to hand-held trimmers and more particularly to a method for manufacturing a hand-held hair trimmer with a non-slip handle for an enhanced grip.

2. Description of Prior Art

Hand held hair trimmers of the type to which the present invention relates are known in the art, see for example D488,260 issued to Khubani on, Apr. 6, 2004. Those trimmers commonly include a rigid elongated, generally cylindrical housing made of plastic or metal. The front end of the housing carries a stationary blade and a movable blade situated in side-by-side relation. The housing encloses a motor for reciprocating the movable blade. The back end of the housing is provided with an open recess adapted to receive a battery for energizing the motor. A switch with an exposed actuator is provided to conditionally connect the battery and the motor to reciprocate the moveable blade.

A hollow cylindrical metal handle is provided. The handle has a housing-receiving channel and an open end. The back end of the housing is slidingly received within the handle channel such the battery-receiving recess is covered. The housing can be withdrawn from the handle to replace the battery.

In order to permit the housing to be withdrawn from the handle without the application of an unduly large amount of force, it is necessary to form the exterior of the housing and the interior of the handle recess with relatively low friction surfaces. However, since the handle is made of metal, the exterior surface of the handle tends to be slippery, particularly when the hands of the user are moist. Moreover, the exterior surface of a metal handle is hard and not very pleasing to the touch.

The exterior surface of the handle could be coated with a non-slip material such as rubber or plastic to provide a handle with an enhanced grip and a softer feel. However, reliably coating the exterior of the metal handle with a non-slip material layer is without coating the interior adds considerably to the cost of the trimmer. Since hair trimmers of this type are designed to be a relatively low cost item, the extra expense of coating the handle exterior is contraindicated.

It is therefore a prime object of the present invention to provide a method for manufacturing a hair trimmer with a non-slip handle for enhanced grip.

It is another object of the present invention to provide a method for inexpensively manufacturing a hair trimmer with a non-slip handle inexpensively.

It is another object to provide a method of manufacturing a hair trimmer with a non-slip handle utilizing an intermediate metal member between the housing and the grip portion of the handle assembly such that the grip can be fabricated entirely of non-slip material.

In accordance with the present invention, a method is provided for manufacturing a hand-held hair trimmer. The trimmer has a rigid housing carrying a stationary blade, a movable blade and a motor for moving the movable blade relative to the stationary blade. A recess is provided in the housing for receiving a battery to energize the motor. The manufacturing method includes forming an intermediate member. First and second semi-tubular grip parts are also formed. A handle assembly with a channel is formed by placing the intermediate member between the grip parts and by fixing the grip parts to the intermediate member, and to each other. A portion of the housing is inserted into the handle assembly channel. The housing is releaseably connected to the handle assembly in order to permit the housing to be withdrawn from the handle assembly for battery replacement.

Preferably the intermediate member is fabricated of metal. It is formed to have a tubular configuration.

The method also includes the steps of forming a protrusion on the intermediate member and forming a protrusion-receiving recess on the handle assembly. The protrusion is received within the protrusion-receiving recess to define the rotational relationship between the intermediate member and grip parts, before the intermediate member is fixed to the grip parts.

The step of forming the grip parts includes the step of forming the grip parts of non-slip material.

The step of fixing the grip parts to the intermediate member comprises the step of providing an adhesive layer between the member and the grip parts.

### BRIEF DESCRIPTION OF THE SEVERAL VIEWS OF DRAWINGS

To these and to such other objects that may hereinafter appear, the present invention relates to a method for manufacturing a hand-held hair trimmer with a non-slip handle, as set forth in detail in the following specification and recited in the annexed claims, taken together with the accompanying drawings, wherein like numerals refer to like parts, and in which:

FIG. 1 is a view of the back of the head and neck of a person using the trimmer of the present invention;

FIG. 2 is an isometric view of the trimmer of the present invention;

FIG. 3 is a view of the trimmer similar to that of FIG. 1, with the cover removed;

FIG. 4 is an exploded isometric view of the trimmer;

FIG. 5 is an exploded isometric view of the handle assembly; and

FIG. 6 is an enlarged, fragmentary, partially cut-away view illustrating the releasable connection between the housing and the handle assembly.

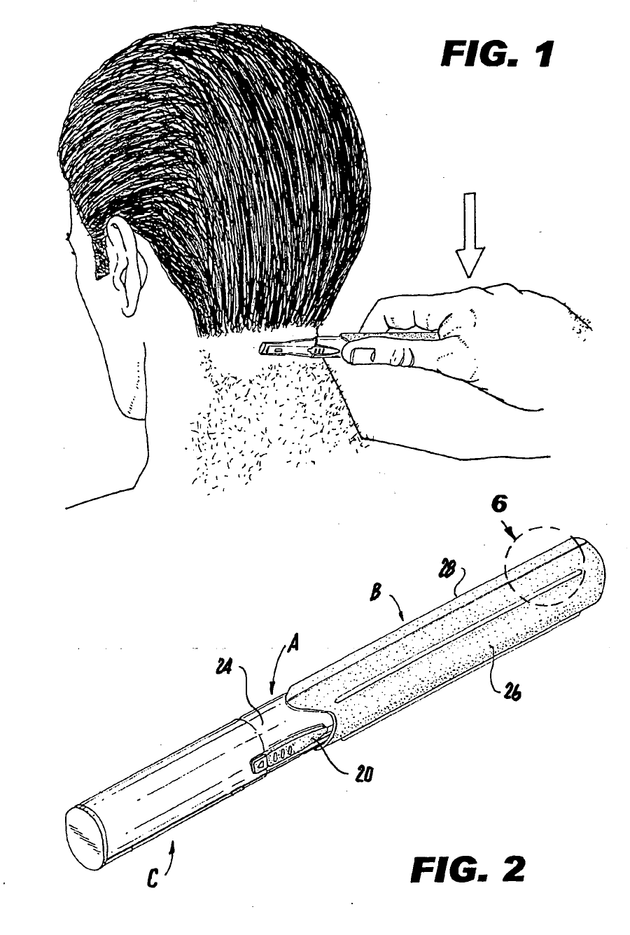

As seen in FIG. 1, the hand-held hair trimmer resulting from the manufacturing method of the present invention is designed for use in removing unwanted hair from the body, for example in the head and neck area. The trimmer is light in weight and relatively inexpensive to manufacture. Although trimmers having this appearance are known, for example, see US D497,035 issued to Khubani on Oct. 4, 2004, they were not previously manufactured by the process of the present invention.

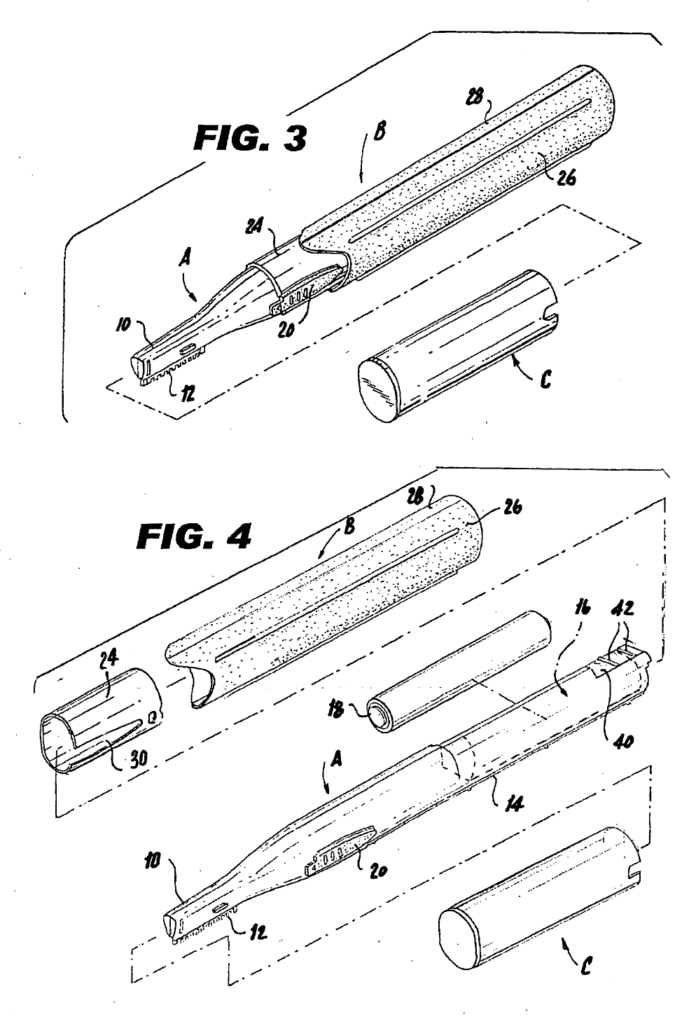

The parts of the trimmer are shown in exploded isometric in FIG. 4. The assembled trimmer is illustrated in FIGS. 2 and 3, with the cover mounted and removed, respectively.

The trimmer includes a rigid housing, generally designated A, preferably made of plastic with metal parts. Housing A has a tapered front end 10 which carries a pair of metal cutting blades 12, situated in side-by-side relation. One of the blades 12 is stationary, being fixed to the housing. The other blade 12 is movably mounted on the housing such that it can be reciprocated relative to the stationary blade by a small electric motor (not shown) situated within the housing.

The back end 14 of housing A defines an open recess 16 adapted to receive a battery 18. Battery 18 is conditionally connected to the motor through a slide switch situated within the housing A, also not shown. An actuator 20 for the slide switch is exposed on the housing surface and is movable along the housing surface in the direction of the longitudinal axis of the housing to conditionally connect the battery to energize the motor.

The wall of the housing adjacent the battery-receiving recess 16 is open to permit battery 18 to be inserted into and removed from the housing. The back end 14 of housing A is received within the handle assembly, generally designed B, in order to cover the battery-receiving recess opening in order to protect the battery and to prevent the battery from accidentally falling out of the housing.

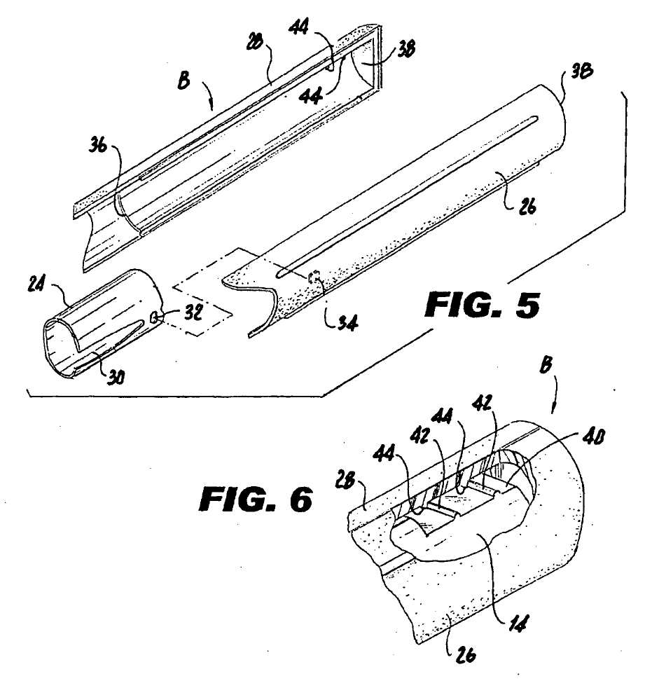

As is best seen in FIG. 5, handle assembly B includes a grip portion 22 and an intermediate member 24. Grip 22 portion is preferably formed of two mirror image grip parts 26, 28 in the form of semi-tubular halves with one closed end. Parts 26, 28 are composed entirely of non-slip material, such as hard rubber or plastic. Grip parts 26, 28 are preferably separately injection molded and thereafter assembled around intermediate member 24 to form the handle assembly.

Member 24 is tubular. It is and preferably formed by cutting a tube into sections. The tube is preferably made of metal, such as aluminum or other rigid material with a relatively smooth interior surface. A recess 30 is cut into the tube section that forms the member to accommodate the switch actuator 20.

Member 24 is also provided with an outwardly directed protrusion 32. The interior surface of one of the grip parts 26 is provided with a recess 34. Recess 34 is adapted to receive protrusion 32 on member 24 as the grip parts 26, 28 are assembled around member 24 to define the rotational relationship between the intermediate member and the grip portion.

Further, a shoulder 36 is cut or molded into the interior surface of one or both of the grip parts. Shoulder 36 defines the axial position of member 24 relative to the grip portion.

Grip parts 26, 28 are preferably joined together to form a hollow cylinder encircling a portion of member 24 using adhesive deposited along the edges of the parts. However, other conventional joining techniques such as heat or sonic welding could be employed. Adhesive is preferred because no special equipment is required. In addition, a layer of adhesive is preferably situated between the exterior surface of member 24 and the interior surfaces of the grip parts to permanently and securely fix member 24 to the grip portion.

Handle assembly B defines an internal channel with a closed end at the rear. The closed end of the handle assembly channel is formed by the semicircular end parts 38 of the grip parts. The interior diameter of the portion of the handle assembly channel defined by member 24 is preferably slightly smaller than the interior diameter of the channel portion defined by the grip parts. The interior diameter of member 24 is slightly larger than the diameter of the exterior surface of housing A proximate switch actuation 20 such that the housing can be inserted into and removed from the handle assembly with relative ease.

Means are provided for releasably connecting the housing to the handle assembly in the fully inserted position of the housing within the handle assembly. The connecting means serves to retain the housing within the handle assembly in the proper position in “snap-fit” fashion, when the housing is fully inserted into the handle assembly.

The connecting means are illustrated in FIG. 6. The rear most portion of the back end 14 of housing A is provided with a recessed planar section 40. Extending upwardly from the surface of section 40 are a pair of longitudinally spaced, transversely extending, elongated, protrusions or ribs 42. The interior surface of the handle assembly carries a second pair of longitudinally spaced, transversely extending, elongated protrusions or ribs 44.

Ribs 42 on housing A cooperate with ribs 44 on handle assembly B to retain the housing in the desired position within the handle assembly, as illustrated in FIG. 6. However, by the application of a small amount of force, the engagement between the ribs pairs can be overcome to permit the housing to be withdrawn from the handle assembly for battery replacement.

Referring back to FIGS. 2-4, a cover, generally designated C, is provided to enclose the front end 10 of housing A to keep blades 12 clean and to isolate the blades from contact with foreign objects that might result in damage to the blades. Preferably, cover C is made of metal, such as aluminum.

It will now be appreciated that the present invention relates to a method for manufacturing a hand-held hair trimmer with a non-slip handle which utilizes an intermediate tubular metal member interposed between the blade-carrying housing and the non-slip grip portion of the handle to permit easy insertion and withdrawal of the housing relative to the handle assembly.

While only a single preferred embodiment of the present invention has been disclosed for purposes of illustration, it is obvious that many variations and modifications could be made thereto. It is intended to cover all of those modifications and variations that fall within the scope of the present invention, as defined by the following claims:

We claim:

1. A method of manufacturing a hand-held hair trimmer of the type having a rigid housing carrying a stationary blade, a moveable blade and a motor for moving the movable blade relative to the stationary blade when energized by a battery received in a recess in the housing, the method comprising the steps of:
forming an intermediate member;
forming first and second semi-tubular grip parts;
forming a handle assembly with a channel by placing the member between the grip parts and by fixing the grip parts to the member and to each other;
inserting a portion of the housing into the channel of the handle assembly; and
releaseably connecting the housing and the handle assembly.

2. The method of claim 1 wherein the step of forming the handle assembly comprising the steps of:
forming a protrusion on the intermediate member;
forming a protrusion-receiving recess in one of the grip parts; and
aligning the protrusion and protrusion-receiving recess prior to fixing the member to the parts.

3. The method of claim 1 further comprising the step of forming the grip parts of non-slip material.

4. The method of claim 1 wherein the step of forming the intermediate member comprises the step of forming the intermediate member of the metal.

5. The method of claim 1 wherein the step of forming the intermediate member comprises the step of forming the intermediate member to have a tubular configuration.

6. The method of claim 1 wherein the portion of the housing that is inserted in the handle assembly channel includes the battery-receiving recess.

7. The method of claim 1 wherein the step of forming the handle assembly comprises the step of interposing an adhesive layer between the intermediate member and the grip parts.
